(19) United States
(12) Patent Application Publication
(10) Pub. No.: US 2025/0028903 A1
(43) Pub. Date: Jan. 23, 2025

(54) CREATING A GRAMMAR REPRESENTING MULTIPLE CONCEPTS AND MULTIPLE RELATIONSHIPS BASED ON A CORPUS OF DATA ASSOCIATED WITH A WIRELESS TELECOMMUNICATION NETWORK

(71) Applicant: T-Mobile USA, Inc., Bellevue, WA (US)

(72) Inventors: Sridhar Bethamsetty, Frisco, TX (US); Vikas Ranjan, Bellevue, WA (US); Diglio Antonio Simoni, Raleigh, NC (US)

(21) Appl. No.: 18/355,311

(22) Filed: Jul. 19, 2023

(51) Int. Cl. G06F 40/253

(52) U.S. Cl. CPC G06F 40/253

(57) ABSTRACT

The system obtains a corpus of data, and extracts triples from the corpus. A first element in a triple indicates a first record in the corpus, a second element in the triple indicates a second record in the corpus, and a third element in the triple indicates a relationship between the first and second records. The system generates grammars representing the triples. A grammar includes concepts and relationships. The concepts include a first and a second concept representing the first and the second record, respectively. The relationships represent the relationship between the first and second records. The system applies each grammar to the triples to obtain an indication of whether each triple is correct. Based on the indication of whether each triple is correct, the system determines an accuracy of each grammar. Based on the accuracy of each grammar, the system selects a grammar having the highest accuracy.

### BACKGROUND

Frequently, new databases need to be integrated into already existing databases, but the two databases may not be compatible. For example, the two databases can represent different relationships and different ontologies. In a large database, such as a database associated with a wireless telecommunication network, merging the two databases and discovering latent relationships is a slow, error-prone, and laborious process. Furthermore, the databases can contain corrupt data, making the merging even more difficult.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 shows a system to create a grammar representing multiple concepts and multiple relationships based on a corpus of data associated with a wireless telecommunication network.

FIG. 3 shows use of a grammar to identify inconsistencies in the data.

FIG. 4 shows application of a grammar to identify spam.

FIG. 5 shows application of a grammar to identify root causes of issues with the network.

FIG. 6 shows application of a grammar to identify information campaigns relevant to users.

FIG. 7 is a flowchart of a method to create a grammar representing multiple concepts and multiple relationships based on a corpus of data associated with a wireless telecommunication network.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to create a grammar representing multiple concepts and multiple relationships based on a corpus of data associated with a wireless telecommunication network. The system obtains the corpus of data associated with the wireless telecommunication network, and extracts from the corpus of data multiple triples representing the corpus of data. Element A in a triple among the multiple triples indicates a record A among the corpus of data, element B in the triple indicates a record B among the corpus of data, and element C in the triple indicates a relationship between the record A and the record B. The record A and the record B can indicate a person, a data record, a report, a file, an electronic device, or a process running on the electronic device.

The system generates multiple grammars representing the multiple triples, where the grammar among the multiple grammars includes the multiple concepts and the multiple relationships. The multiple concepts include a concept A representing the record A, and a concept B representing the record B. The multiple relationships represent the relationship between the record A and the record B. For example, the system converts a triple (Joe, likes, Pixel 6) to a grammar including (person, has affinity for, Android devices), where person and Android devices are concepts, and the relationship is “has affinity for.” The concepts “person” and “Android devices” are generalizations of the data “Joe” and “Pixel 6,” respectively, while the relationship “has affinity for” also is a generalization of the relationship “likes.”

The system applies each grammar among the multiple grammars to the multiple triples to obtain an indication of whether each triple among the multiple triples is correct according to the grammar. Based on the indication of whether each triple among the multiple triples is correct, the system determines an accuracy associated with each grammar among the multiple grammars. Based on the accuracy associated with each grammar among the multiple grammars, the system selects a grammar having the highest accuracy among the multiple grammars.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

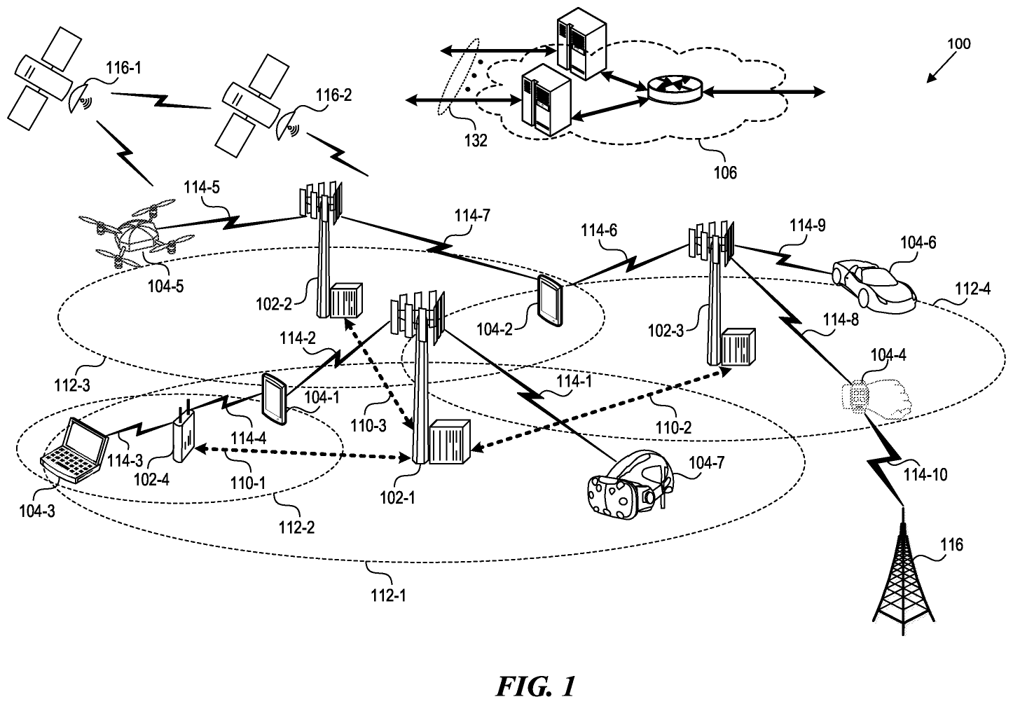

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service requirements and multi-terabits-per-second data transmission in the era of 6G and beyond, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

Creating a Grammar Representing Multiple Concepts and Multiple Relationships Based on a Corpus of Data Associated with a Wireless Telecommunication Network

The growth in the complexity and size of data in the enterprise continues unbridled. Organizations of all sizes, but particularly large ones (e.g., 100,000+employees, 1,000,000+customers) operating globally and supported by large and geographically distributed software development groups with long histories of successful complex deployments, are impacted by the stresses involved in the maintenance of long-running software systems and the concomitantly substantial number of processes deployed to handle massive amounts of data. The heterogeneous distributed nature of the information gathering process, in combination with the large and varied ways in which such information is processed, leads to large lacunae in terms of overall system observability, at the very least, resulting in wide data quality gaps, loss of identification in terms of efficiencies regarding space and time considerations (multiple data copies and multiple equivalent processing workflows), and doubtful certainty regarding the trust with which the obtained results at any point in time are entirely matching of the reality of the data being analyzed, given the particulars of the SLAs (Service Level Agreements) in effect. Enterprises operate facing the nonlinear stochastic behavior of myriad processes, whose complex behavior is not only daunting in scope, but mysterious, since there may exist many hidden processing constraints or data conduits which remain latent but invisible, whose repercussions could surface unpredictably due to lack of accountability or transparency. This situation results tremendous challenges in terms of locating, matching, sharing and securely disseminating information, all throughout its entire lifecycle, from the moment it's gathered at the source to the moment it's consumed by the rightful consumer.

The need to handle increasingly larger amounts of data generates tremendously burdensome data storage and computational requirements, which can only be met at a heavy cost to the enterprise. In addition, since our modern information technologies project the illusion that “everything” is readily available at the touch of your fingertips, data consumers increasingly expect close to real-time access to any enterprise-level data driven by the incorrect perception that “if the data is there, then I must be able to make use of it immediately”. To handle the increasing user demand for data, regardless of its source, contemporary trends point to the use of graph-based representations, which capture both the important entities existent in the data as well as their relationships. However, the task involved in “translating” a corpus of data from either a traditional relational model or some unstructured form, or both, is daunting. A method that could facilitate the automatic construction of a graph that captures the essential aspects present in the corpus would be especially useful. Even if the method resulted in an approximate graph representation, this would accelerate the construction of a more agile and expandable way of representing the data, due to the benefits of graph technologies for specific use cases, where relational models fail to scale. This is particularly important in situations where the schema of the source data changes unpredictably.

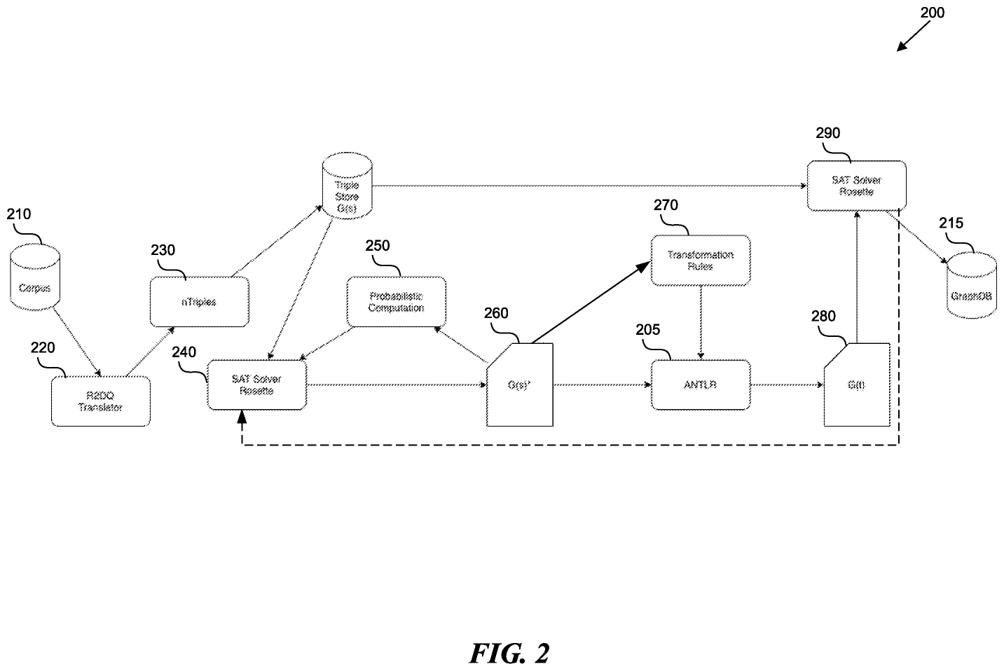

FIG. 2 shows a system to create a grammar representing multiple concepts and multiple relationships based on a corpus of data associated with a wireless telecommunication network. The system 200 includes a corpus of data 210, a translator 220, multiple triples Gs 230, a first satisfiability solver 240, a probabilistic computation 250, multiple grammars Gs* 260, transformation rules 270, a target grammar (“grammar”) Gt 280, and a second satisfiability solver 290.

The disclosed system 200 combines new artificial intelligence (AI)/machine learning (ML) advances in the natural language processing (NLP) space to produce a graph representation of a source corpus of data. This system 200 can serve as an essential component of a data access layer which is robust against unpredictable changes in the implicit schema of the source corpora 210. A fundamental insight is to think of the denormalized version of the source corpus 210 as sets of statements, i.e., one of more programs, in some unknown (malformed) grammar Gs 230.

Given Gs, the system 200 can infer a covering grammar Gs* 260 and use Gs* to parse the source data 210. Parsing errors drive a self-correcting iterative optimization process to refine Gs* (to within some p). The system 200 can use a combination of data-driven proposal learning, deep learning, approximate Bayesian computation, differentiable parsing, conditional independences in parallel, parsing pipelines and fast solver-aided optimization of DSLs (Domain Specific Language).

The system 200 analyzes Gs* analyzed to construct an ontology that describes the source domain 210. The system uses the ontology to derive transformation rules to convert Gs* 260 into a new target grammar Gt 280. Gt is used to transpile the source data 210 into a graph representation.

The corpus of data 210 can store data associated with the network 100 in FIG. 1. The corpus of data 210 can be stored in a relational database management system, and can represent data regarding interactions between a UE and the network 100, issues reported with the network 100, user preferences, etc.

The translator 220 can convert the corpus of data 210 into multiple triples 230. Each triple can include a first element representing a first record, a second element representing a second record, and a third element representing a relationship between the first record and the second record. For example, the first and the second records can represent people, servers, electronic devices, data, tables, reports, code repositories, processes running electronic devices, etc. For example, a triple can be (Joe, likes, ice cream). In another example, a triple can relate to words in a sentence such as a verb and an adverb. The relationship can indicate a distance between the two words such as (slowly, is close to, running). In a third example, a triple can indicate a developer of a code such as (Jon Smith, develop, flow stream code). For example, a triple can indicate a language of a particular code such as (OpenGL, written in, C).

The first satisfiability solver 240 can convert the multiple triples 230 to multiple grammars 260. A grammar is a list of general concepts and relationships between general concepts. A grammar can be a generalized version of the multiple triples 230. For example, the concepts in the grammar can encompass the first and second records in the multiple triples 230, while the relationships in the grammar can encompass the relationships represented by the multiple triples 230. The first satisfiability solver 240 can be a Monte Carlo solver, or a reinforcement learning artificial intelligence (AI). The first satisfiability solver 240 can receive the multiple triples 230 as inputs, and can produce a grammar as output.

For example, the first satisfiability solver 240 can convert the triple (Joe, likes, ice cream) in the multiple triples 230 to (person, has affinity for, food), where person and food are concepts, and the relationship is “has affinity for.” The concepts “person” and “food” are generalizations of the data “Joe” and “ice cream,” respectively, while the relationship “has affinity for” also is a generalization of the relationship “likes.” As can be seen from the previous example, a single grammar triple can represent many triples among the multiple triples 230. Consequently, a grammar has considerably fewer elements than the multiple triples 230, and occupies less memory. In effect, a grammar is a compressed way to represent the multiple triples 230.

There can be multiple first satisfiability solvers 240 running simultaneously, each one producing one or more different grammars to generate the multiple grammars 260. The probabilistic computation 250 can apply each grammar among the multiple grammars 260 to the multiple triples 230 to determine whether each triple among the multiple triples 230 is correct, that is, to determine whether each triple among the multiple triples 230 is valid under the grammar 260. A triple is valid under the grammar 260 if the triple can be generated by the grammar 260. Multiple grammars 260 can identify varying numbers of multiple triples as incorrect. For example, grammar A among the multiple grammars 260 can identify 50% of the triples among the multiple triples 230 as incorrect, while grammar B among the multiple grammars 260 can identify 20% of the triples among the multiple triples as incorrect. The probabilistic computation 250 can gather the accuracy of the various grammars, such as 50% for grammar A and 20% for grammar B, and can select the grammar that has the highest accuracy.

In addition, the process can be iterative, and the probabilistic computation 250 can provide the highest accuracy grammar back to the first satisfiability solver 240 to improve upon the highest accuracy grammar. After the accuracy of the highest accuracy grammar reaches a certain threshold, such as 10% accuracy, the probabilistic computation 250 can provide the highest accuracy grammar to the transformation rules 270.

The transformation rules 270 can transform the highest accuracy grammar to a different format. For example, the transformation rules 270 can transform the highest accuracy grammar from a text format to a graph to obtain the grammar 280.

The second satisfiability solver 290 can validate the grammar 280 by applying the grammar 280 to additional triples not used in generating the grammar 280. The second satisfiability solver 290 can measure the percentage of the additional triples that the grammar 280 identified as incorrect. If the percentage of the additional triples exceeds a third certain threshold such as 20%, the second satisfiability solver 290 can provide the first satisfiability solver 240 to the grammar 280 to improve the grammar 280.

The system 200 assumes that the input data 210 expresses statements in some unknown language. The system's iterative process attempts to guess/infer a language which maximizes the ability to parse the data.

The following is a sample process, using the unstructured corpus case as an example. The system 200 starts with a corpus of information 210, e.g. a bag of documents.

The first task is to convert the corpus of information 210 into triples. The system 200 can use standard NLP to do the usual things, e.g. segment, tokenize, etc. to find elements. This means that the system 200 has some sense of the types of elements to identify. The system 200 can be primed with such a set. The system 200 can use various techniques to locate relationships between those tokens. The system 200 can produce multiple triples 230, there statistics, and locations where they appear. The multiple triples 230 define a large set of statements in the unknown language whose grammar the system 200 wants to infer.

The essential task is to use Solver-Aided Programming to generate a grammar Gs* 260, in the form of a solver-aided domain-specific language (SDSL), i.e., a language, which is able to parse the statements in the input set. These models use various libraries that implement Satisfiability Module Theories. The SAT solver 240 can be Rosette.

In addition, since there's a large element of uncertainty involved, those derived constructs Gs* 260 could be used to generate probabilistic programs, e.g. Dimple. With every iteration, the accuracy of the derived grammar Gs* 260 is evaluated against a sampling of the input set 210.

When the system 200 reach some threshold p, e.g. 10% accuracy, we can extract from the inferred grammar Gs* 260 sets of elements and relationships that generate the ontology which should be a subset or a derived set from the raw set of triples 230 obtained from the source corpus 210. The system 200 can use that ontology to derive transformation rules 270, and in turn convert the transformation rules into ANTLR rules 205, or Codon rules to obtain the transport grammar Gt 280. The system 200 can feed the transformed grammar Gt 280 into the SAT solver 290, e.g. a Rosette, which can then convert the transformed grammar GT 280 into a graph representation 215, e.g. graphDB.

Overall, the system 200 uses a combination of techniques that induces an iterative self-optimizing procedure for corpus transformation from a relational or unstructured data format to a graph representation 215. Once the graph 215 is constructed, it can be used as a data routing mechanism to locate source data elements and any related entities quickly. The graph 215 can also contain information about access privileges, such that permissions can be guaranteed to be always heeded.

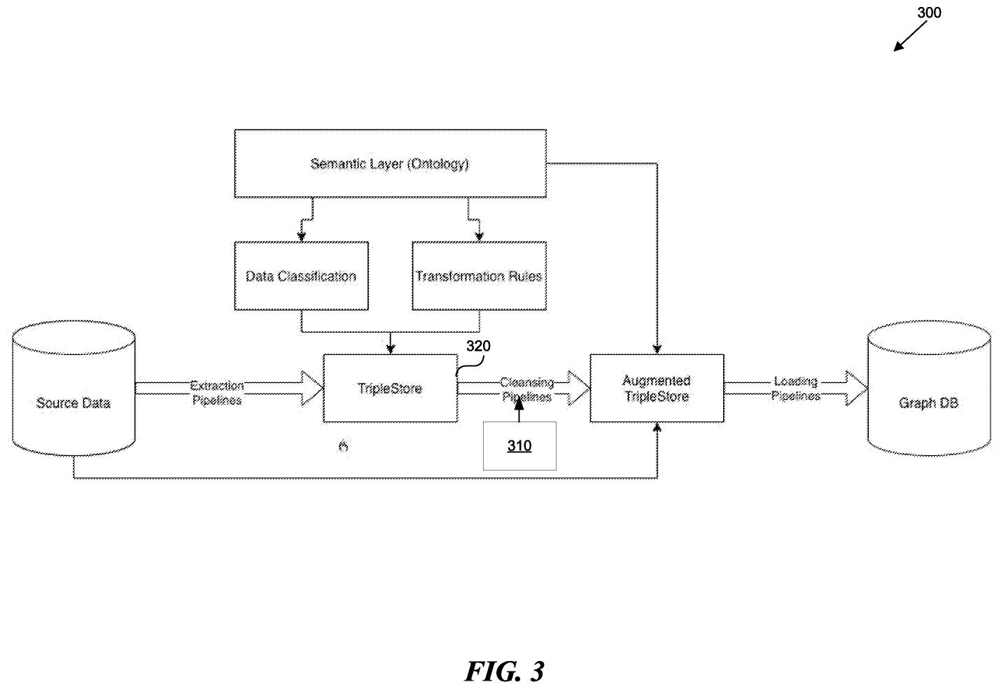

FIG. 3 shows use of a grammar to identify inconsistencies in the data. The system 300 can apply the grammar 310 to multiple triples 320 to identify inconsistencies among the multiple triples such as a typo in the data, a missing element, or an incorrect relationship. For example, when the grammar 310 identifies the triple as incorrect, the reason for the incorrect results can be inconsistency in the triple. Consequently, when the grammar identifies an incorrect result, the system 300 can produce a notification that the incorrect triple contains inconsistent data.

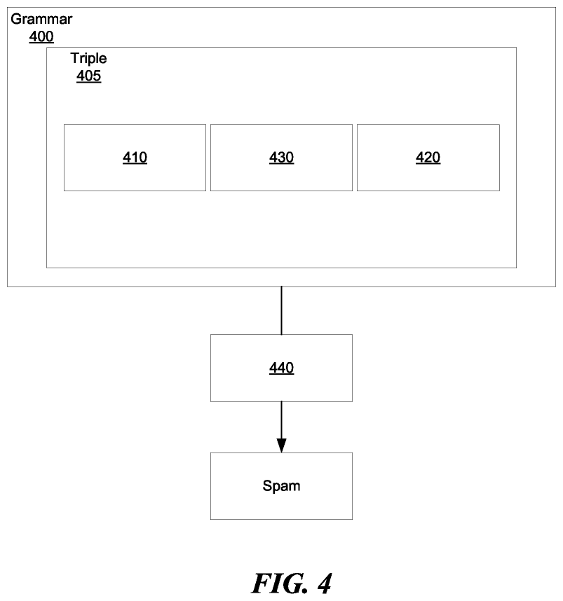

FIG. 4 shows application of a grammar to identify spam. The corpus of data 210 in FIG. 2 can include messages between two UEs. Consequently, the grammar 400 can include a triple 405 representing the corpus of data 210. The triple 405 can include element 410 representing the first UE, element 420 representing a second UE, and element 430 representing content of the message sent between the first and the second UE. The content of the message can include the language in which the message is written. The messages can be Rich Communication Services (RCS), Short Message Service (SMS), Rapid Message Service (RMS), email, etc.

The grammar 400 can be applied to a new message 440 to determine whether the new message deviates from the previously established grammar. For example, the message 440 can be in a different language, can come from an unknown sender, or can include abnormal content. When the grammar 400 is applied to the new message 440, the grammar can detect that the message 440 is not valid according to the grammar rules, and the grammar 400 can detect the message as spam.

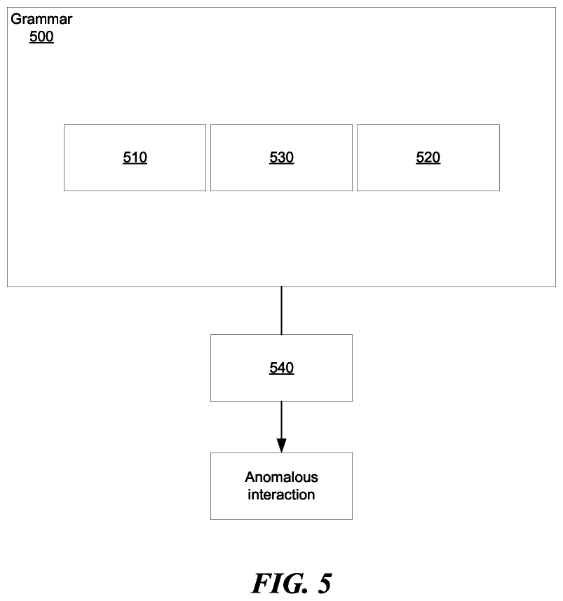

FIG. 5 shows application of a grammar to identify root causes of issues with the network 100 in FIG. 1. The grammar 500 can describe how components 510, 520 of the network 100 interact with each other through a relationship 530. The components 510, 520 can include a core network, a radio network, and an IP network. When there is an outage in the network 100, there can be an interaction 540 between various components 510, 520 of the network 100 that is not recognized by the grammar 500. The grammar 500 can identify anomalous interaction 540, thus indicating an interaction associated with the outage and the root cause of the outage.

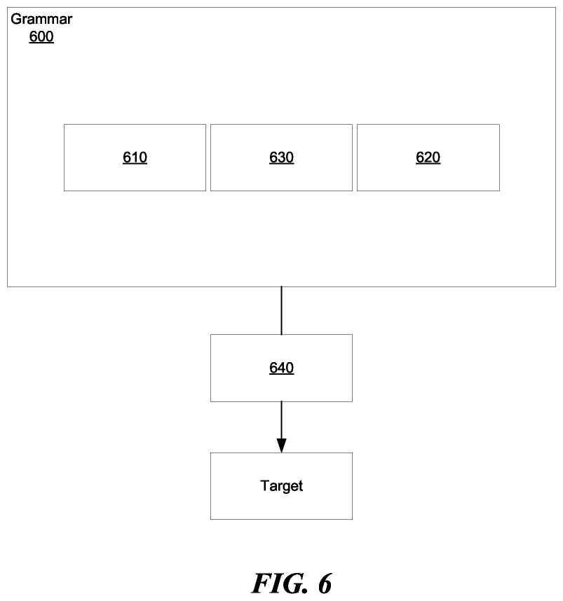

FIG. 6 shows application of a grammar to identify information campaigns relevant to users. The grammar 600 can represent interactions between a UE 610 and a component 620 associated the network 100, where the component 620 can include information retrieved via the network such as sports content, social media content, news content, etc. The interaction 630 can be “frequently retrieves” and can indicate that the UE frequently retrieves sports content, or social media content.

The information campaign 640 can be associated with the component 620. For example, the information campaign 640 can be broadcast on the component 620, such as a particular channel. Consequently, the system can determine a target, e.g., that the UE 610 should be exposed to the information campaign 640 through a particular channel, such as social media, a news website, or a sports website. In another example, the information campaign 640 can target people consuming sports content. Consequently, the system can present the information campaign 640 to the UE 610.

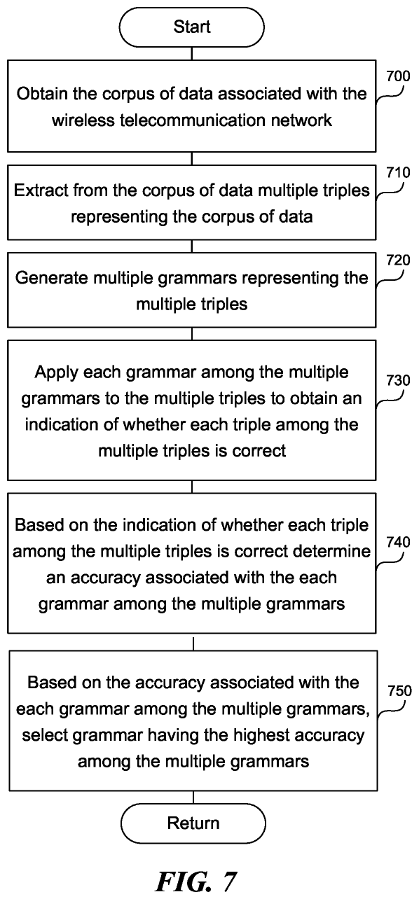

FIG. 7 is a flowchart of a method to create a grammar representing multiple concepts and multiple relationships based on a corpus of data associated with a wireless telecommunication network. A hardware or software processor executing instructions described in this application can, in step 700, obtain the corpus of data associated with the wireless telecommunication network.

In step 710, the processor can extract from the corpus of data multiple triples representing the corpus of data, where a first element in a triple among the multiple triples indicates a first record among the corpus of data, where a second element in the triple among the multiple triples indicates a second record among the corpus of data, and where a third element in the triple indicates a relationship between the first record and the second record. The first record and the second record can be a person, a data record, a report, a file, an electronic device, or a process running on the electronic device. The processor can use AI to extract from the corpus of data the multiple triples.

In step 720, the processor can generate multiple grammars representing the multiple triples. A grammar among the multiple grammars can be a set of rules and can include include multiple concepts and multiple relationships. The multiple concepts include a first concept representing the first record, and a second concept representing the second record. The multiple relationships represent the relationship between the first record and the second record. For example, a triple can represent (Joe, likes, ice cream). The corresponding grammar can represent the triple using concepts and relationships (person, has affinity for, food).

In step 730, the processor can apply each grammar among the multiple grammars to the multiple triples to obtain an indication of whether each triple among the multiple triples is correct according to the grammar.

In step 740, based on the indication of whether each triple among the multiple triples is correct, the processor can determine an accuracy associated with each grammar among the multiple grammars.

In step 750, based on the accuracy associated with each grammar among the multiple grammars, the processor can select a grammar having the highest accuracy among the multiple grammars.

The processor can use the grammar to detect spam. The processor can obtain the corpus of data associated with the wireless telecommunication network. The corpus of data can include multiple messages passed between multiple UEs associated with the wireless telecommunication network. The processor can extract from the corpus of data multiple triples representing the corpus of data, where a first element in a triple among the multiple triples indicates a first UE, where a second element in the triple indicates a second UE, and where a third element in the triple indicates a property of a message passed between the first UE and the second UE. The property can indicate the language the message is written in and/or the content of the message. The processor can obtain a first message passed between the first UE and the second UE, where the message is not among the multiple messages. The processor can create a first triple including the first UE, the second UE, and a property associated with the first message. The processor can apply the grammar to the first triple to obtain an indication of whether the first triple is correct. Upon obtaining the indication that the first triple is incorrect, the processor can determine that the message is a spam message.

The processor can use the grammar to perform root cause analysis. The processor can obtain the corpus of data associated with the wireless telecommunication network, where the corpus of data includes multiple relationships between multiple components of the wireless telecommunication network. The multiple components can include a radio network, a core network, and an IP network. The processor can extract from the corpus of data multiple triples representing the corpus of data, where the a element in a triple among the multiple triples indicates a first component of the wireless telecommunication network, where a second element in the triple among the multiple triples indicates a second component of the wireless telecommunication network, and where a third element in the triple among the multiple triples indicates a relationship between the first component and the second component. The property can indicate language and/or content of the message. The processor can obtain an indication of a failure associated with the wireless telecommunication network. The processor can obtain an interaction between the first component and the second component. The processor can create a first triple including the first component, the second component, and the interaction. The processor can apply the grammar to the first triple to obtain an indication of whether the first triple is correct. Upon obtaining the indication that the first triple is incorrect, the processor can determine that the interaction between the first component and the second component is associated with the failure associated with the wireless telecommunication network. The interaction can be indicative of the root cause.

The processor can use the grammar to create personalized marketing offers. The processor can obtain the corpus of data associated with the wireless telecommunication network. The corpus of data can include multiple interactions between a user of a UE and a first component associated with the wireless telecommunication network, such as a sports website, a social media website, etc. The processor can extract from the corpus of data multiple triples representing the corpus of data, where a first element in a triple among the multiple triples indicates the UE, where a second element in the triple indicates the first component associated with the wireless telecommunication network, and where a third element in the triple indicates the interaction between the UE and the first component associated with the wireless telecommunication network. The interaction can indicate that the UE “frequently consumes” the second element, such as a social media website. The processor can obtain an information campaign associated with the wireless telecommunication network, and a second component associated with the wireless telecommunication network and associated with the information campaign. The second component can be a channel through which the information campaign can be presented to the user, or an indication of the content of the information campaign such as advertising for a sports event. The processor can determine whether the first component and the second component correspond to each other. The processor can determine correspondence based on the grammar, by turning the first component into a more abstract component in the grammar and turning the second component into a more abstract component in the grammar. Upon determining that the first component and the second component correspond to each other, the processor can present the information campaign to the user of the UE.

The processor can use the grammar to identify incorrect data in the corpus of data. The processor can apply the grammar to the multiple triples representing the corpus of data to identify a subset of the multiple triples that are incorrect according to the grammar. The processor can tag the subset of the multiple triples as invalid data. The incorrect data can have a missing element, a typo in the data, etc.

Once deployed, the processor can monitor the grammar performance on new data, and provide feedback to the system to improve the grammar. Specifically, the processor can obtain a second corpus of data, different from the corpus of data. The second corpus of data and the first corpus of data are related in that they represent a same type of data, such as performance of various UE models on the network. The processor can extract from the second corpus of data a second multiplicity of triples representing the second corpus of data. The processor can apply the grammar to the second corpus of data to obtain a second accuracy associated with the grammar and the second corpus of data. The processor can adjust the grammar based on the second accuracy.

### Computer System

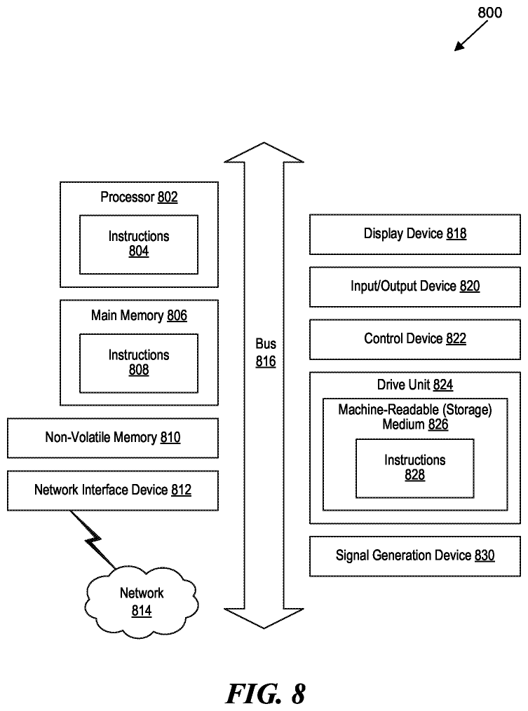

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 800. In some implementations, the computer system 800 can be an embedded computer system, a system-on-chip (SOC), a single-board computer system (SBC), or a distributed system such as a mesh of computer systems, or can include one or more cloud components in one or more networks. Where appropriate, one or more computer systems 800 can perform operations in real time, in near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/we claim:

1. A non-transitory, computer-readable storage medium comprising instructions recorded thereon to create a grammar representing multiple concepts and multiple relationships based on a corpus of data associated with a wireless telecommunication network, wherein the instructions, when executed by at least one processor of a system of the wireless telecommunication network, cause the system to:
obtain the corpus of data associated with the wireless telecommunication network;
extract, from the corpus of data, multiple triples representing the corpus of data,
wherein a first element in a triple among the multiple triples indicates a first record among the corpus of data,
wherein a second element in the triple among the multiple triples indicates a second record among the corpus of data,
wherein a third element in the triple among the multiple triples indicates a relationship between the first record and the second record,
wherein the first record and the second record are configured to indicate a data record, a mobile device associated with the wireless telecommunication network, or a process running on the mobile device associated with the wireless telecommunication network;
generate multiple grammars representing the multiple triples,
wherein the grammar among the multiple grammars includes the multiple concepts and the multiple relationships,
wherein the multiple concepts include a first concept representing the first record and a second concept representing the second record,
wherein the multiple relationships represent the relationship between the first record and the second record;
apply each grammar among the multiple grammars to the multiple triples to obtain an indication of whether each triple among the multiple triples is correct;
based on the indication of whether each triple among the multiple triples is correct, determine an accuracy associated with the each grammar among the multiple grammars; and
based on the accuracy associated with the each grammar among the multiple grammars, select a grammar having a highest accuracy among the multiple grammars.

2. The non-transitory, computer-readable storage medium of claim 1, comprising instructions to:
wherein the corpus of data includes multiple messages passed between multiple mobile devices associated with the wireless telecommunication network, wherein the first element in the triple among the multiple triples indicates a first mobile device,
wherein the second element in the triple among the multiple triples indicates a second mobile device,
wherein the third element in the triple among the multiple triples indicates a property of a message passed between the first mobile device and the second mobile device;
obtain a first message passed between the first mobile device and the second mobile device,
wherein the message is not among the multiple messages;
create a first triple including the first mobile device, the second mobile device, and a property associated with the first message;
apply the grammar to the first triple to obtain an indication of whether the first triple is correct; and
upon obtaining the indication that the first triple is incorrect, determine that the message is a spam message.

3. The non-transitory, computer-readable storage medium of claim 1, comprising instructions to:
wherein the corpus of data includes multiple relationships between multiple components of the wireless telecommunication network,
wherein the multiple components include a radio network, a core network, and an Internet protocol (IP) network,
wherein the first element in the triple among the multiple triples indicates a first component of the wireless telecommunication network,
wherein the second element in the triple among the multiple triples indicates a second component of the wireless telecommunication network,
wherein the third element in the triple among the multiple triples indicates a relationship between the first component and the second component;
obtain an indication of a failure associated with the wireless telecommunication network;
obtain an interaction between the first component and the second component;
create a first triple including the first component, the second component, and the interaction;
apply the grammar to the first triple to obtain an indication of whether the first triple is correct; and
upon obtaining the indication that the first triple is incorrect, determine that the interaction between the first component and the second component is associated with the failure associated with the wireless telecommunication network.

4. The non-transitory, computer-readable storage medium of claim 1, comprising instructions to:
wherein the corpus of data includes multiple interactions between a user of a mobile device and a first component associated with the wireless telecommunication network,
wherein the first element in the triple among the multiple triples indicates the mobile device,
wherein the second element in the triple among the multiple triples indicates the first component associated with the wireless telecommunication network,
wherein the third element in the triple among the multiple triples indicates an interaction between the mobile device and the first component associated with the wireless telecommunication network;
obtain an information campaign associated with the wireless telecommunication network, and a second component associated with the wireless telecommunication network and associated with the information campaign;
determine whether the first component and the second component correspond to each other; and
upon determining that the first component and the second component correspond to each other, present the information campaign to the user of the mobile device.

5. The non-transitory, computer-readable storage medium of claim 1, comprising instructions to:
apply the grammar to the multiple triples representing the corpus of data to identify a subset of the multiple triples that are incorrect according to the grammar; and
tag the subset of the multiple triples as invalid data.

6. The non-transitory, computer-readable storage medium of claim 1, wherein the instructions to extract the multiple triples comprise instructions to:
obtain a second corpus of data;
extract, from the second corpus of data, a second multiplicity of triples representing the second corpus of data;
apply the grammar to the second corpus of data to obtain a second accuracy associated with the grammar and the second corpus of data; and
adjust the grammar based on the second accuracy.

7. The non-transitory, computer-readable storage medium of claim 1, wherein the instructions to extract the multiple triples comprise instructions to:
use artificial intelligence (AI) to extract, from the corpus of data, the multiple triples.

8. A method comprising:
extracting, from a corpus of data associated with a wireless telecommunication network, multiple triples representing the corpus of data,
wherein first and second elements in a triple among the multiple triples respectively indicate first and second records among the corpus of data,
wherein a third element in the triple among the multiple triples indicates a relationship between the first and second records;
generating multiple grammars representing the multiple triples,
wherein a grammar among the multiple grammars includes multiple concepts and multiple relationships,
wherein the multiple concepts include first and second concepts representing the first and second records, respectively,
wherein the multiple relationships represent the relationship between the first and second records;
applying each grammar among the multiple grammars to the multiple triples to obtain an indication of whether each triple among the multiple triples is correct;
based on the indication of whether each triple among the multiple triples is correct, determining an accuracy associated with the each grammar among the multiple grammars; and
based on the accuracy associated with each grammar among the multiple grammars, selecting a grammar having a highest accuracy among the multiple grammars.

9. The method of claim 8, comprising:
obtaining a corpus of data associated with the wireless telecommunication network,
wherein the corpus of data includes multiple messages passed between multiple UEs associated with the wireless telecommunication network;
wherein the first element in the triple among the multiple triples indicates a first UE,
wherein the second element in the triple among the multiple triples indicates a second UE,
wherein the third element in the triple among the multiple triples indicates a property of a message passed between the first UE and the second UE;
obtaining a first message passed between the first UE and the second UE,
wherein the first message is not among the multiple messages;
creating a first triple including the first UE, the second UE, and a property associated with the first message;
applying the grammar to the first triple to obtain an indication of whether the first triple is correct; and
upon obtaining the indication that the first triple is incorrect, determining that the message is a spam message.

10. The method of claim 8, comprising:
obtaining the corpus of data associated with the wireless telecommunication network,
wherein the corpus of data includes multiple relationships between multiple components of the wireless telecommunication network,
wherein the multiple components include a radio network, a core network, and an Internet protocol (IP) network;
wherein the first element in the triple among the multiple triples indicates a first component of the wireless telecommunication network,
wherein the second element in the triple among the multiple triples indicates a second component of the wireless telecommunication network,
wherein the third element in the triple among the multiple triples indicates a relationship between the first component and the second component;
obtaining an indication of a failure associated with the wireless telecommunication network;
obtaining an interaction between the first component and the second component;
creating a first triple including the first component, the second component, and the interaction;
applying the grammar to the first triple to obtain an indication of whether the first triple is correct; and
upon obtaining the indication that the first triple is incorrect, determining that the interaction between the first component and the second component is associated with the failure associated with the wireless telecommunication network.

11. The method of claim 8, comprising:
obtaining the corpus of data associated with the wireless telecommunication network,
wherein the corpus of data includes multiple interactions between a user of a UE and a first component associated with the wireless telecommunication network;
wherein the first element in the triple among the multiple triples indicates the UE,
wherein the second element in the triple among the multiple triples indicates the first component associated with the wireless telecommunication network,
wherein the third element in the triple among the multiple triples indicates an interaction between the UE and the first component associated with the wireless telecommunication network;
obtaining an information campaign associated with the wireless telecommunication network, and a second component associated with the wireless telecommunication network and associated with the information campaign;
determining whether the first component and the second component correspond to each other; and
upon determining that the first component and the second component correspond to each other, presenting the information campaign to the user of the UE.

12. The method of claim 8, comprising:
applying the grammar to the multiple triples representing the corpus of data to identify a subset of the multiple triples that are incorrect according to the grammar; and
tagging the subset of the multiple triples as invalid data.

13. The method of claim 8, wherein extracting the multiple triples comprises:
obtaining a second corpus of data;
extracting, from the second corpus of data, a second multiplicity of triples representing the second corpus of data;
applying the grammar to the second corpus of data to obtain a second accuracy associated with the grammar and the second corpus of data; and
adjusting the grammar based on the second accuracy.

14. A system comprising:
at least one hardware processor; and
at least one non-transitory memory storing instructions, which, when executed by the
at least one hardware processor, cause the system to:
extract, from a corpus of data associated with a wireless telecommunication network, multiple triples representing the corpus of data,
wherein a first element in a triple among the multiple triples indicates a first record among the corpus of data,
wherein a second element in the triple among the multiple triples indicates a second record among the corpus of data,
wherein a third element in the triple among the multiple triples indicates a relationship between the first record and the second record;
generate multiple sets of rules representing the multiple triples,
wherein a set of rules among the multiple sets of rules includes multiple concepts and multiple relationships,
wherein the multiple concepts include a first concept representing the first record and a second concept representing the second record,
wherein the multiple relationships represent the relationship between the first record and the second record;
apply each set of rules among the multiple sets of rules to the multiple triples to obtain an indication of whether each triple among the multiple triples is correct;
based on the indication of whether each triple among the multiple triples is correct, determine an accuracy associated with each set of rules among the multiple sets of rules; and
based on the accuracy associated with each set of rules among the multiple sets of rules, select a set of rules having a highest accuracy among the multiple sets of rules.

15. The system of claim 14, comprising instructions to:
obtain the corpus of data associated with the wireless telecommunication network,
wherein the corpus of data includes multiple messages passed between multiple UEs associated with the wireless telecommunication network;
wherein the first element in the triple among the multiple triples indicates a first UE,
wherein the second element in the triple among the multiple triples indicates a second UE,
wherein the third element in the triple among the multiple triples indicates a property of a message passed between the first UE and the second UE;
obtain a first message passed between the first UE and the second UE, wherein the first message is not among the multiple messages;
create a first triple including the first UE, the second UE, and a property associated with the first message;
apply the set of rules to the first triple to obtain an indication of whether the first triple is correct; and
upon obtaining the indication that the first triple is incorrect, determine that the message is a spam message.

16. The system of claim 14, comprising instructions to:
obtain the corpus of data associated with the wireless telecommunication network,
wherein the corpus of data includes multiple relationships between multiple components of the wireless telecommunication network,
wherein the multiple components include a radio network, a core network, and an Internet protocol (IP) network;
wherein the first element in the triple among the multiple triples indicates a first component of the wireless telecommunication network,
wherein the second element in the triple among the multiple triples indicates a second component of the wireless telecommunication network,
wherein the third element in the triple among the multiple triples indicates a relationship between the first component and the second component;
obtain an indication of a failure associated with the wireless telecommunication network;
obtain an interaction between the first component and the second component;
create a first triple including the first component, the second component, and the interaction;
apply the set of rules to the first triple to obtain an indication of whether the first triple is correct; and
upon obtaining the indication that the first triple is incorrect, determine that the interaction between the first component and the second component is associated with the failure associated with the wireless telecommunication network.

17. The system of claim 14, comprising instructions to:
obtain the corpus of data associated with the wireless telecommunication network,
wherein the corpus of data includes multiple interactions between a user of a UE and a first component associated with the wireless telecommunication network;
wherein the first element in the triple among the multiple triples indicates the UE,
wherein the second element in the triple among the multiple triples indicates the first component associated with the wireless telecommunication network,
wherein the third element in the triple among the multiple triples indicates an interaction between the UE and the first component associated with the wireless telecommunication network;
obtain an information campaign associated with the wireless telecommunication network, and a second component associated with the wireless telecommunication network and associated with the information campaign;
determine whether the first component and the second component correspond to each other; and
upon determining that the first component and the second component correspond to each other, present the information campaign to the user of the UE.

18. The system of claim 14, comprising instructions to:
apply the set of rules to the multiple triples representing the corpus of data to identify a subset of the multiple triples that are incorrect according to the set of rules; and
tag the subset of the multiple triples as invalid data.

19. The system of claim 14, wherein the instructions to extract, from the corpus of data, the multiple triples comprise instructions to:
obtain a second corpus of data;
extract, from the second corpus of data, a second multiplicity of triples representing the second corpus of data;
apply the set of rules to the second corpus of data to obtain a second accuracy associated with the set of rules and the second corpus of data; and
adjust the set of rules based on the second accuracy.

20. The system of claim 14, wherein the instructions to extract, from the corpus of data, the multiple triples comprise instructions to:
use artificial intelligence (AI) to extract, from the corpus of data, the multiple triples.
